(19) United States
(12) Patent Application Publication
(10) Pub. No.: US 2012/0206619 A1
(43) Pub. Date: Aug. 16, 2012

(54) IMAGE PROCESSING APPARATUS, IMAGE CAPTURING APPARATUS AND RECORDING MEDIUM

(75) Inventors: Keiichi NITTA, Kawasaki-shi (JP); Koichi SAKAMOTO, Asaka-shi (JP); Akihiko TAKAHASHI, Kawasaki-shi (JP); Fumihiko FUTABA, Tokyo (JP)

(73) Assignee: NIKON CORPORATION, Tokyo (JP)

(21) Appl. No.: 13/350,182

(22) Filed: Jan. 13, 2012

(30) Foreign Application Priority Data
Jan. 25, 2011 (JP) 2011-013216

(51) Int. Cl. H04N 5/228; G06K 9/46

(52) U.S. Cl. 348/222.1; 382/103; 348/E05.031

(57) ABSTRACT

An image processing apparatus comprising an image acquiring section that acquires a plurality of images captured in time sequence; a subject extracting section that extracts a plurality of different subjects contained in the plurality of images; and a main subject inferring section that determines the position of each subject in each of the images, and infers which of the subjects is a main subject in the images based on position information for each of the subjects in the images.

### BACKGROUND

1. Technical Field

The present invention relates to an image processing apparatus, an image capturing apparatus, and a recording medium.

2. Related Art

Japanese Patent Application Publication No. 2009-089174 describes a digital camera that performs image capturing using image capturing conditions suitable for an important subject by excluding subjects that do not change in a plurality of images acquired in time sequence.

However, with the digital camera of Patent Document 1, in a case where the time between image captures is short, there is little change in a subject between images and it is difficult to identify the main subject. Furthermore, with the digital camera of Patent Document 1, it is assumed that a moving subject is the main subject, but there are actually many cases in which there are a plurality of moving subjects, and the photographer does not necessarily intend to capture all of these subjects. Therefore, in order to realize a function for performing image capturing with image capturing conditions suitable for the main subject or for extracting an image in which the captured state of the main subject looks good (referred to hereinafter as “picture quality”) from among a plurality of frames of captured images, improvement is desired for the accuracy of the inference for the main subject in the image.

### SUMMARY

Therefore, it is an object of an aspect of the innovations herein to provide an image processing apparatus, an image capturing apparatus, and a recording medium, which are capable of overcoming the above drawbacks accompanying the related art. The above and other objects can be achieved by combinations described in the independent claims. According to a first aspect related to the innovations herein, provided is an image processing apparatus comprising an image acquiring section that acquires a plurality of images captured in time sequence; a subject extracting section that extracts a plurality of different subjects contained in the plurality of images; and a main subject inferring section that determines the position of each subject in each of the images, and infers which of the subjects is a main subject in the images based on position information for each of the subjects in the images.

According to a second aspect related to the innovations herein, provided is an image capturing apparatus comprising the image processing apparatus described above; a release button that is operated by a user; and an image capturing section that captures the plurality of images in response to a single operation of the release button.

According to a third aspect related to the innovations herein, provided is a program that causes a computing device to capture a plurality of images in time sequence; extract a plurality of different subjects contained in the plurality of images; and determine a position of each subject in each of the images, and infer which of the subjects is a main subject in the images based on position information for each of the subjects in the images.

The summary clause does not necessarily describe all necessary features of the embodiments of the present invention. The present invention may also be a sub-combination of the features described above.

### BRIEF DESCRIPTION OF THE DRAWINGS

FIG. 1 is a perspective view of the digital camera 100.

FIG. 2 is a perspective view of the digital camera 100.

FIG. 3 is a block diagram of the internal circuit 200 of the digital camera 100.

FIG. 4 is a flow chart showing the operational processes of the main subject inferring section 270.

FIG. 5 is a schematic view of an exemplary captured image group 410.

FIG. 6 schematically shows operation of the candidate subject selecting section 260.

FIG. 7 schematically shows operation of the candidate subject selecting section 260.

FIG. 8 schematically shows operation of the candidate subject selecting section 260.

FIG. 9 schematically shows operation of the candidate subject selecting section 260.

FIG. 10 is a flow chart showing the operational processes of the main subject inferring section 270.

FIG. 11 schematically shows operation of the main subject inferring section 270.

FIG. 12 schematically shows operation of the main subject inferring section 270.

FIG. 13 schematically shows operation of the main subject inferring section 270.

FIG. 14 schematically shows operation of the main subject inferring section 270.

FIG. 15 is a flow chart showing the operational processes of the image selecting section 280.

FIG. 16 schematically shows operation of the image selecting section 280.

FIG. 17 schematically shows operation of the image selecting section 280.

FIG. 18 schematically shows operation of the image selecting section 280.

FIG. 19 schematically shows operation of the image selecting section 280.

FIG. 20 schematically shows operation of the image selecting section 280.

FIG. 21 schematically shows operation of the image selecting section 280.

FIG. 22 schematically shows a personal computer that executes an image processing program.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

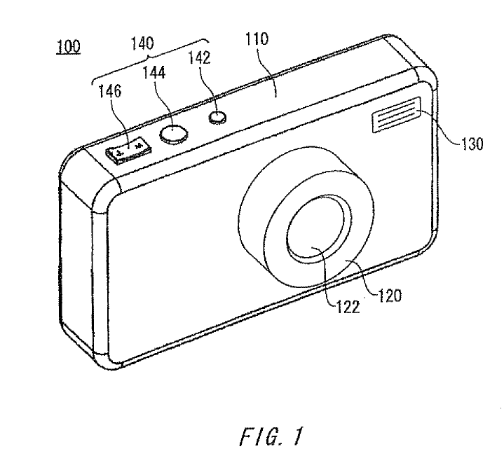

FIG. 1 is a perspective view of a digital camera 100, which is one type of image capturing apparatus, as seen diagonally from the front. The digital camera 100 includes a substantially cubic chassis 110 that is thin from front to rear, a lens barrel 120 and a light emitting window 130 arranged on the front surface of the chassis 110, and an operating portion 140 that has a power supply switch 142, a release button 144, and a zoom lever 146, for example, arranged on the top surface of the chassis 110.

The lens barrel 120 holds a photography lens 122 that focuses a subject image on an image capturing element arranged within the chassis 110. Light generated by a light emitting section, not shown, arranged in the chassis 110 illuminates the subject through the light emitting window 130.

The power supply switch 142 turns the power supply of the digital camera 100 ON or OFF each time the power supply switch 142 is pressed. The zoom lever 146 changes the magnification of a photography lens held by the lens barrel 120.

In a case where the release button 144 is pressed half way by a user, an automatic focusing section and a photometric sensor, for example, are driven and a through-image capturing operation is performed by the image capturing element. Therefore, after the through-image capturing, the digital camera 100 can perform the main image capturing of the subject image. In a case where the release button 144 is fully pressed, the shutter opens and the main image capturing operation of the subject image is performed. In a case where the image capturing region is dark, for example, light from the light emitting window 130 is projected toward the subject at the timing of the main image capturing.

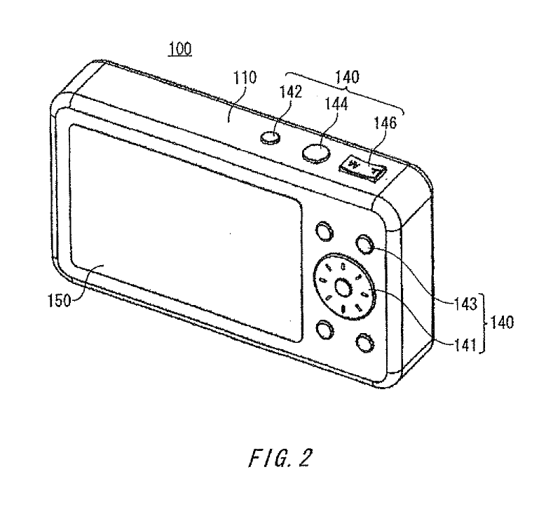

FIG. 2 is a perspective view of the digital camera 100 as seen diagonally from the rear. Components that are the same as those in FIG. 1 are given the same reference numerals and redundant explanations are omitted.

A rear display section 150 and a portion of the operating portion 140 that includes a cross-shaped key 141 and a rear surface button 143, for example, are arranged on the rear surface of the chassis 110. The cross-shaped key 141 and the rear surface button 143 are operated by the user in a case of inputting various settings in the digital camera 100 or in a case of switching the operating mode of the digital camera 100.

The rear display section 150 is formed by a liquid crystal display panel, for example, and covers a large region of the rear surface of the chassis 110. In a case of the through-image capturing mode, for example, the digital camera 100 uses the image capturing element to continuously photoelectrically convert the subject image incident to the lens barrel 120, and displays the result of the photoelectric conversion in the rear display section 150 as the captured image. The user can be made aware of the effective image capturing range by viewing the through-image displayed in the rear display section 150.

The rear display section 150 displays remaining battery life and remaining capacity of a storage medium that can store captured image data, together with the state of the digital camera 100. Furthermore, in a case where the digital camera 100 is operating in a playback mode, the captured image data is read from the storage medium and the corresponding image is displayed in the rear display section 150.

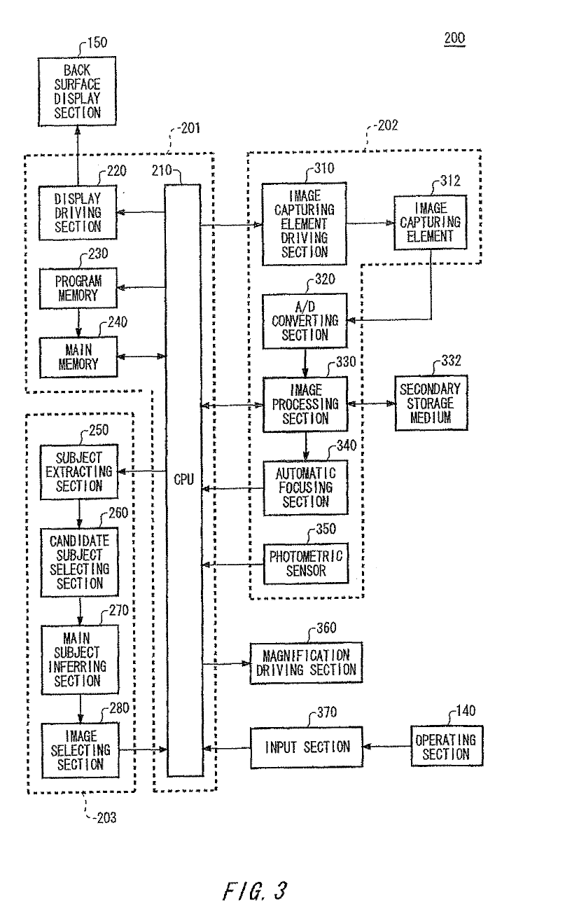

FIG. 3 is a block diagram schematically showing an internal circuit 200 of the digital camera 100. Components that are the same as those shown in FIGS. 1 and 2 are given the same reference numerals and redundant explanations are omitted. The internal circuit 200 includes a control section 201, an image acquiring section 202, and a captured image processing section 203.

The control section 201 is formed by a CPU 210, a display driving section 220, a program memory 230, and a main memory 240. The CPU 210 comprehensively controls the operation of the digital camera 100, according to firmware read to the main memory 240 from the program memory 230. The display driving section 220 generates a display image according to instructions from the CPU 210, and displays the generated image in the rear display section 150.

The image acquiring section 202 includes an image capturing element driving section 310, an image capturing element 312, an analog/digital converting section 320, an image processing section 330, an automatic focusing section 340, and a photometric sensor 350.

The image capturing element driving section 310 drives the image capturing element 312 to generate an image signal by photoelectrically converting the subject image focused on the surface of the image capturing element 312 by the photography lens 122. A CCD (Charge Coupled Device) or CMOS (Complementary Metal Oxide Semiconductor), for example, can be used as the image capturing element 312.

The image signal output by the image capturing element 312 is digitized by the analog/digital converting section 320 and converted to captured image data by the image processing section 330. The image processing section 330 applies white balance, sharpness, gamma, and grayscale correction to the generated captured image data, and adjusts the compression rate or the like when storing the generated captured image data in the secondary storage medium 332, described further below.

The image data generated by the image processing section 330 is stored and saved in the secondary storage medium 332. A medium including a non-volatile storage device such as a flash memory, for example, is used as the secondary storage medium 332. At least a portion of the secondary storage medium 332 can be detached from the digital camera 100 and replaced.

In order to realize display in the rear display section 150 during through-image capturing, the automatic focusing section 340 determines that the photography lens 122 is focused when the contrast of a predetermined region of the captured image is at a maximum, as a result of the user pressing the release button 144 half way. The photometric sensor 350 measures the brightness of the subject and determines image capturing conditions of the digital camera 100. The magnification driving unit 360 moves a portion of the photography lens 122 according to instructions from the CPU 210. In this way, the magnification of the photography lens 122 is changed and the angle of field of the captured image is also changed.

The input section 370 handles input from the operating portion 140 and stores setting values set in the digital camera 100, for example. The CPU 210 references the input section 370 to determine operating conditions.

The digital camera 100 including the internal circuit 200 described above has an image capturing mode in which the image acquiring section 202 acquires image data for a plurality of frames in response to one image capturing operation of the user pressing the release button 144, i.e. the full-pressing operation. When settings are made for this image capturing mode, the CPU 210 uses the image capturing element driving section 310 to control the image capturing element 312 in a manner to perform continuous image capturing.

In this way, time-sequence captured image (moving image) data is obtained. The time-sequence captured image data obtained in this way is sequentially input to a FIFO (First In First Out) memory in the image processing section 330. The FIFO memory has a predetermined capacity, and when the sequentially input data reaches a predetermined amount, the captured image data is output in the order in which it was input. In the image capturing mode described above, the time-sequence captured image data is sequentially input to the FIFO memory during a period extending a predetermined time from when the user fully presses the release button 144, and the data output from the FIFO memory during this period is deleted.

After the predetermined time has passed from when the release button 144 was fully pressed, writing of the captured image data to the FIFO memory is prohibited. As a result, the time-sequence captured image data including a plurality of frames captured before and after the full pressing operation of the release button 144 is stored in the FIFO memory. In other words, by acquiring the plurality of frame images captured in time sequence by the image acquiring section 202 in response to a single image capturing operation, an image with suitable image capturing conditions (e.g. diaphragm opening, shutter speed, image capturing element sensitivity), image capturing timing, and picture quality of the main subject, for example, can be selected based on the plurality of images. As a result, the success rate of the image capturing can be improved.

Recently, improvements to the rapid shooting function of image capturing elements and the degree of integration of memories, for example, have enabled captured image data including tens of images to be acquired by a single operation of the release button by a user. As a result, the user has an extra task of selecting a handful of images from among this large amount of captured image data.

Therefore, the digital camera 100 includes the captured image processing section 203. The captured image processing section 203 includes a subject extracting section 250, a main subject inferring section 270, and an image selecting section 280, and selects images in which the main subject is captured well from among the captured images. The following describes the operation of the captured image processing section 203.

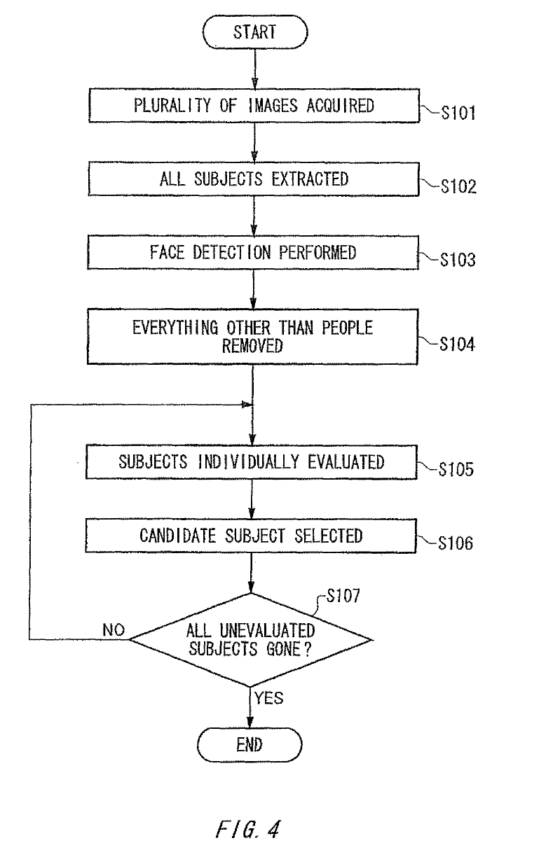

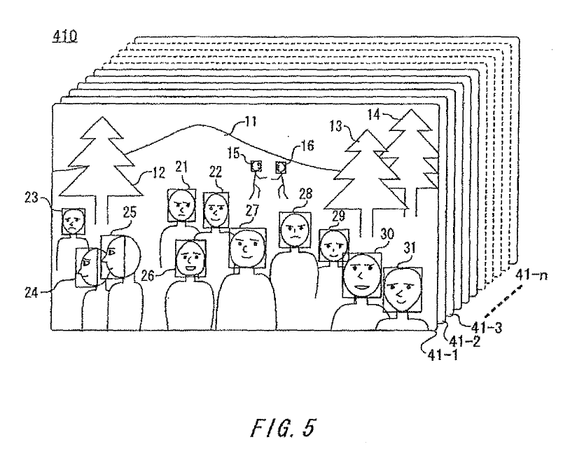

FIG. 4 is a flow chart showing the operational order of the subject extracting section 250 and the candidate subject selecting section 260 in the captured image processing section 203. FIGS. 5 to 9 schematically show a process performed by the subject extracting section 250 and the candidate subject selecting section 260 of the captured image processing section 203, and the following description references these drawings as necessary.

As shown in FIG. 5, the captured image processing section 203 reads from the secondary storage medium 332 a captured image group 410 that includes a plurality of captured images 41-1 to 41-n acquired by the image acquiring section 202 in response to one release operation (full pressing operation) (step S101). The plurality of captured images 41-1 to 41-n are captured in time sequence, but the content differs among the images due to camera shake during the continuous image capturing and change in the state of the subject, for example. The plurality of pieces of captured image data acquired at step 5101 are not limited to data read from the secondary storage medium 332, and may also be captured image data captured by the image capturing element 312 but not yet stored in the secondary storage medium 332.

Next, as shown by the captured image 41-1 in FIG. 5, the captured image processing section 203 uses the subject extracting section 250 to extract all of the subjects 11 to 31 included in each of the captured images 41-1 to 41-n (step S102).

Next, the captured image processing section 203 performs face recognition, i.e. recognizing subjects that are classified in a category of “faces,” for each of the subjects 11 to 31 (step S103). As a result, as shown by the regions enclosed in rectangular frames in FIG. 5, the subjects 15, 16, and 21 to 31 recognized as faces are set as the target subjects for processing, and the other subjects 11 to 14 are excluded from being targets for processing by the captured image processing section 203 (step S104).

The following description uses an example in which a person (face) is assumed to be the target subject for processing, but the processing target is not limited to this. For example, the subject may be a car or a dog instead. Furthermore, the plurality of subjects in the following description are not limited to the same type of subjects, e.g. people's faces, and different types of subject such as both people's faces and dogs' faces may be used, for example.

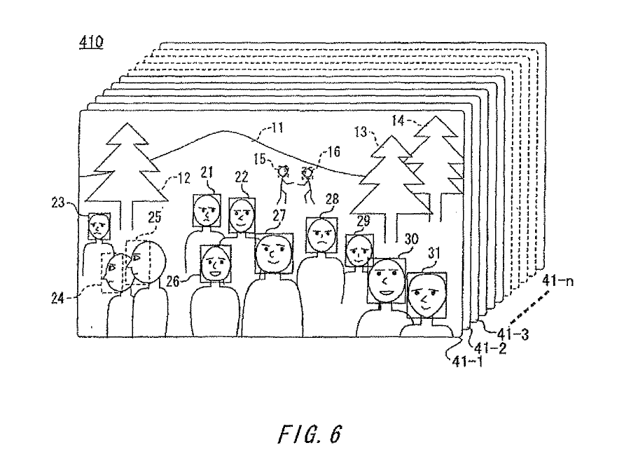

Next, the captured image processing section 203 uses the candidate subject selecting section 260 to determine whether each subject 15 to 31 can be a candidate for the main subject (S105). FIG. 6 shows an example of one subject selection method performed by the candidate subject selecting section 260.

Specifically, the candidate subject selecting section 260 extracts a line of sight for each subject 15 to 31 that has already been recognized as a face, and evaluates the subject based on whether the extracted line of sight is oriented toward the digital camera 100 (step S105).

In FIG. 6, the subjects (faces) having Lines of sight oriented toward the digital camera 100 are surrounded by solid lines. With this evaluation, the candidate subject selecting section 260 selects subjects having lines of sight oriented toward the digital camera 100 as candidate subjects that could be the main subject (step S106).

The candidate subject selecting section 260 repeats the processes of steps S105 and S106 for all of the images acquired at step S101, until there are no more unevaluated subjects in the captured image 41-1 (the NO of step S107). In a case where there are no more unevaluated subjects (the YES of step S107), processing by the candidate subject selecting section 260 is finished.

In this way, the extracted subjects 21 to 23 and 26 to 31 having lines of sight oriented toward the digital camera 100 are selected as candidates for the main subject. The other subjects 15, 16, 24, and 25 are excluded from further processing by the candidate subject selecting section 260.

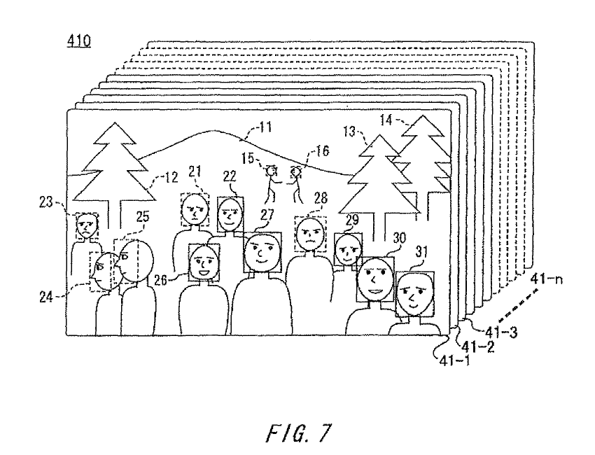

FIG. 7 shows another exemplary evaluation method performed by the candidate subject selecting section 260. Specifically, the candidate subject selecting section 260 performs this evaluation by extracting a feature of a “smile” from the recognized faces (step S105). The candidate subject selecting section 260 selects the subjects 22, 26, 27, 29, 30, and 31, for which the evaluation value (degree of smiling) is greater than or equal to a predetermined value, as the candidate subjects based on the evaluation concerning a smile, i.e. how big of a smile the person has (step S106). In FIG. 7, these subjects (faces) are surrounded by solid lines. The other subjects 21, 23, and 28 are excluded from further processing by the candidate subject selecting section 260.

The candidate subject selecting section 260 may recognize individual entities (specific individuals) that are registered in advance in the digital camera 100 to evaluate the candidate subjects based on affinity with the user of the digital camera 100 (step S105). The affinity between the user and each specific individual is recorded and stored in advance in the digital camera 100 along with an image characteristic amount for recognizing the specific individual. For example, in the present embodiment, among the subjects within the image, specific individuals with degrees of affinity greater than or equal to a predetermined value are extracted as candidate subjects.

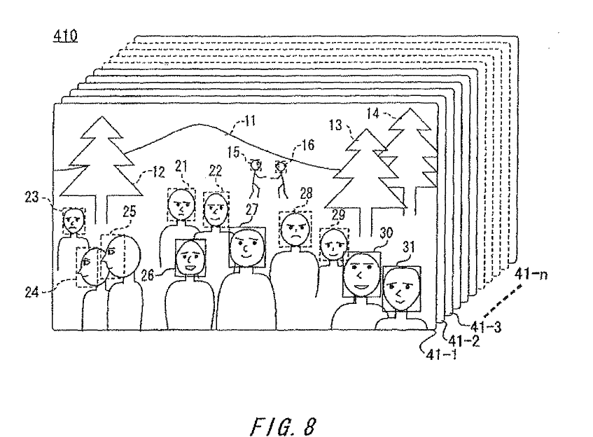

In this way, the subjects 26, 27, 30, and 31 are selected by the candidate subject selecting section 260 in the example of FIG. 8 (step S106). Accordingly, the other subjects 15, 16, 21 to 25, 28, and 29 are excluded from further processing by the candidate subject selecting section 260.

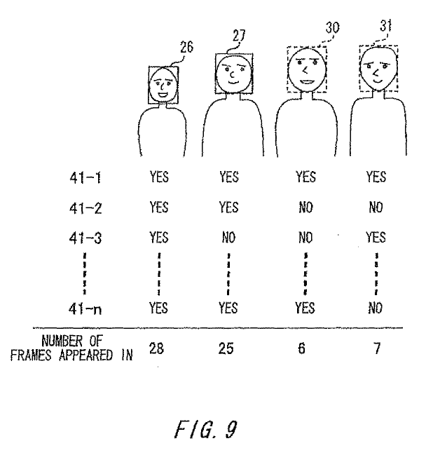

FIG. 9 shows another exemplary evaluation method performed by the candidate subject selecting section 260. The candidate subject selecting section 260 evaluates the subjects by extracting the frequency with which the individual entity of each subject 15 to 31 appears in the plurality of captured images 41-1 to 41-n, i.e. the number of frames in which each individual entity appears among the frames of the plurality of captured images (step S105). In FIG. 9, for ease of explanation, subjects 26, 27, 30, and 31 are used as examples of the subjects appearing in the frames of each captured image.

In this way, the subjects 26 and 27 having high appearance frequency, e.g. subjects that appear in 10 or more frames, are selected by the candidate subject selecting section 260 as the candidate subjects (step S106). Accordingly, the other subjects 30 and 31 are excluded from further processing by the candidate subject selecting section 260.

In this way, the candidate subject selecting section 260 evaluates the subjects that could be candidates for the main subject after individually evaluating the faces of the subjects. Furthermore, the candidate subject selecting section 260 selects subjects that are evaluated highly as the candidate subjects. As a result, the processing load placed on the main subject inferring section 270 described next can be decreased.

It is obvious that the evaluation method and evaluation criteria for the candidate subjects used by the candidate subject selecting section 260 are not limited to the examples described above. The above description includes a plurality of separate examples of the selection operation performed by the candidate subject selecting section 260, but the candidate subject selecting section 260 may perform some or all of these selection operations in combination. In this case, the order in which the evaluations are performed is not limited to the above order.

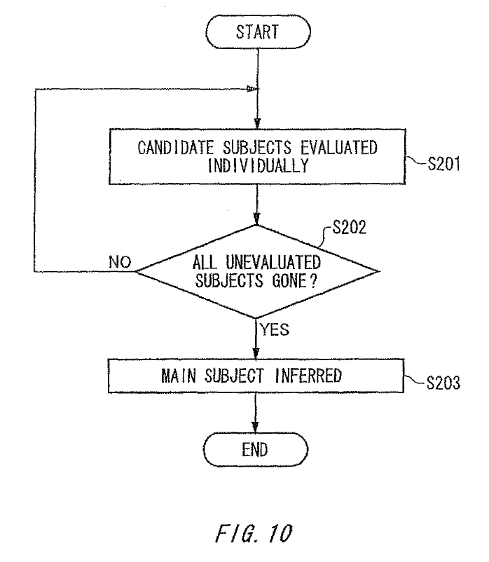

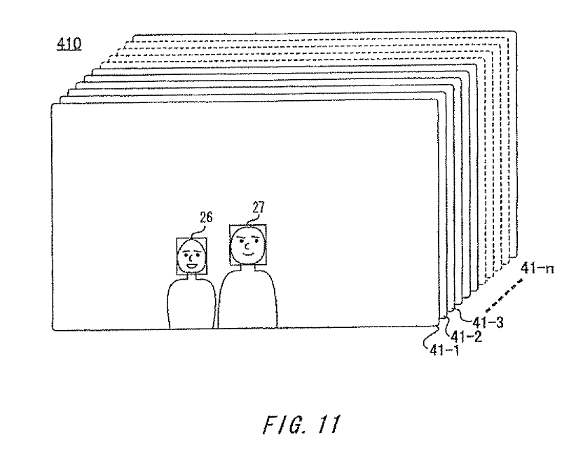

FIG. 10 is a flow chart showing the operating procedure of the main subject inferring section 270 in the captured image processing section 203. FIGS. 11 to 14 schematically show the processes performed by the main subject inferring section 270, and these drawings are referenced in the following description as necessary.

The following describes an example in which the candidate subject selecting section 260 has selected the subjects 26 and 27 as the candidate subjects. As shown in FIG. 11, the captured image processing section 203 causes the main subject inferring section 270 to perform an individual main subject evaluation for each of the subjects 26 and 27 selected as a candidate subject by the candidate subject selecting section 260 (step 5201). The evaluation method may be based on the position of the candidate subjects 26 and 27 in each of the captured images 414 to 41-n, for example.

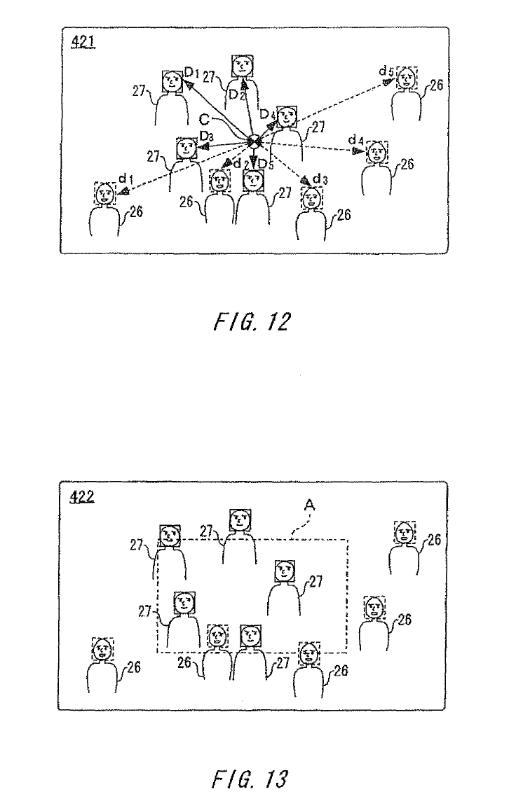

FIG. 12 schematically shows a method performed by the main subject inferring section 270 for evaluating the candidate subjects 26 and 27 based on the position history of the subjects in the screen 421. In FIG. 12, the positions of the candidate subjects 26 and 27 in the captured images 41-1 to 41-5 are displayed in an overlapping manner in a single image.

When capturing images of the subjects, the photographer often sets the image capturing range such that the subject whose image the photographer wants to capture is positioned near the center of the screen. In particular, in a case where the subject the photographer wants to capture is a moving subject that moves within the capture field, the photographer often captures images while moving the camera to keep the subject to be captured positioned near the center of the image.

Therefore, as shown in FIG. 12, the main subject inferring section 270 tracks each of the candidate subjects 26 and 27 in the plurality of captured images 41-1 to 41-n of the digital camera 100 and examines how far the positions of the candidate subjects 26 and 27 are distanced from the center C in each frame of the captured images 41-1 to 41-n. Even if there is a captured image frame in which the face recognition could not properly be achieved, such as a case in which the face ends up pointing backward, during the tracking operation described above, an association can be made for the same subject between frames.

As described further below, among the plurality of acquired captured images 41-1 to 41-n, the subjects captured in frames of captured images acquired at timings near the timing at which the release button 144 is pressed are more likely to be the subject that the user (photographer) intended to capture. Accordingly, the accuracy of the main subject inference can be improved by using the following process, for example.

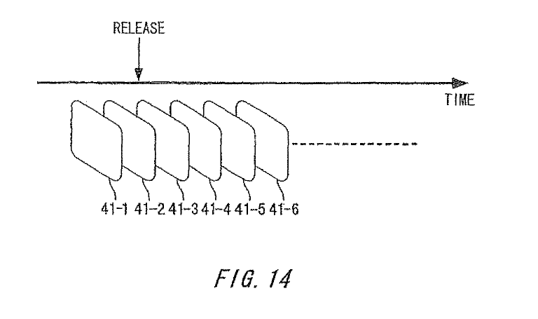

Specifically, the image in one frame determined according to the timing at which the release button 144 is fully pressed, e.g. the captured image 41-3 shown in FIG. 14 (described further below) captured immediately after the release button 144 is fully pressed, is set as the initial frame. Next, a plurality of subjects detected in the initial frame image are individually recognized, in each of a plurality of images (captured images 41-2 and 41-1 in the example of FIG. 14) captured before the initial frame and a plurality of images (captured images 41-4, 41-5, 41-6, etc. in the example of FIG. 14) captured after the initial frame. Next, the position of each of the detected subjects is determined in each of the images.

The main subject inferring section 270 repeats steps S203 and S204 described above, until there are no more unevaluated subjects (the NO of step S202). In a case where there are no more unevaluated subjects (the YES of step S202), the main subject inferring section 270 moves the processing to step S203.

More specifically, the main subject inferring section 270 evaluates the position of the candidate subject 26 in the captured images 414 to 41-5 based on an average value or an integrated value of values corresponding to distances d₁, d₂, d₃, d₄, and d₅ between the candidate subject 26 and the center C in each of the captured images 41-1 to 41-5. Next, the main subject inferring section 270 evaluates the candidate subject 27 in the captured images 414 to 41-5 based on an average value or an integrated value of values corresponding to distances D₁, D₂, D₃, D₄, and D₅ between the candidate subject 27 and the center C in each of the captured images 41-1 to 41-5.

Next, at step S203, the evaluation values acquired for each candidate subject, i.e. the average'values or integrated values corresponding to the distances from the center C of the screen in the above example, are compared to each other. In the example shown in the drawings, this evaluation indicates that the candidate subject 27 is captured more often at a position close to the center C of the captured images than the candidate subject 26. Therefore, the main subject inferring section 270 infers that the candidate subject 27 is the main subject. In this way, the captured image processing section 203 infers the subject 27 to be the main subject, from among the subjects 26 and 27 (step S203). In the above example, the main subject is inferred based on values corresponding to the distance from the center C of each image to the candidate subjects, but the main subject may instead be inferred based on values corresponding to a distance between the candidate subjects and a predetermined point in each image, such as the minimum distance from each point of intersection between lines dividing the image into three equal regions in each of the horizontal and vertical directions or from two of these intersection points at the top of the image capturing screen.

FIG. 13 schematically shows another method performed by the main subject inferring section 270 for evaluating the candidate subjects 26 and 27 based on the position history in the screen 422. As shown in FIG. 13, first, a predetermined region A is set at or near the center of the screen 422 of the digital camera 100. Next, the number of times that the candidate subjects 26 and 27 appear within the predetermined region A in the captured images 41-1 to 41-5 is counted for each of the subjects 26 and 27. The position of the predetermined region A is not limited to the center of the screen, and may be set in a region that is not near the center of the screen depending on the desired composition.

In this way, the candidate subject 27 is determined to be captured a greater number of times within the predetermined region A than the candidate subject 26. Therefore, the main subject inferring section 270 infers that the candidate subject 27 is the main subject.

In this way, the captured image processing section 203 can infer the main subject 27 based on the position of each subject in a plurality of image frames. However, it is obvious that the evaluation method for inferring the main subject 27 based on the position history is not limited to the method described above. For example, with the method shown in FIG. 12, in a case of evaluating the distances D₁, D₂, D₃, D₄, and D₅ from the center C, the evaluation value may be calculated using an additional statistical process, instead of as a simple average. Furthermore, the evaluation may be based on the distance of the subject 27 from the center C of the screen 422 decreasing over time.

FIG. 14 schematically shows an additional method performed by the main subject inferring section 270 for evaluating the candidate subjects 26 and 27. As already described above, the image acquiring section 202 of the digital camera 100 can capture a plurality of images in time sequence in response to a single image capturing operation. Among the captured images 41-1 to 41-n acquired in this way, the candidate subjects 26 and 27 appearing in the images captured at timings near the timing at which the release button 144 was pressed are more likely to be the subject that the photographer intended to capture, as described above.

Accordingly, in a case of evaluating the candidate subjects 26 and 27, more weight may be given to the candidate subjects 26 and 27 appearing in the images captured at timings that are closer to the timing at which the release button 144 is pressed. Furthermore, the evaluation may be performed with more weight given to the candidate subject 27 that is closer to the center C of the screen 421 in the images closer to the release timing or to the candidate subject 27 appearing in the predetermined region A of the screen 421 in the images closer to the release timing. In this way, the accuracy of the main subject inference can be improved.

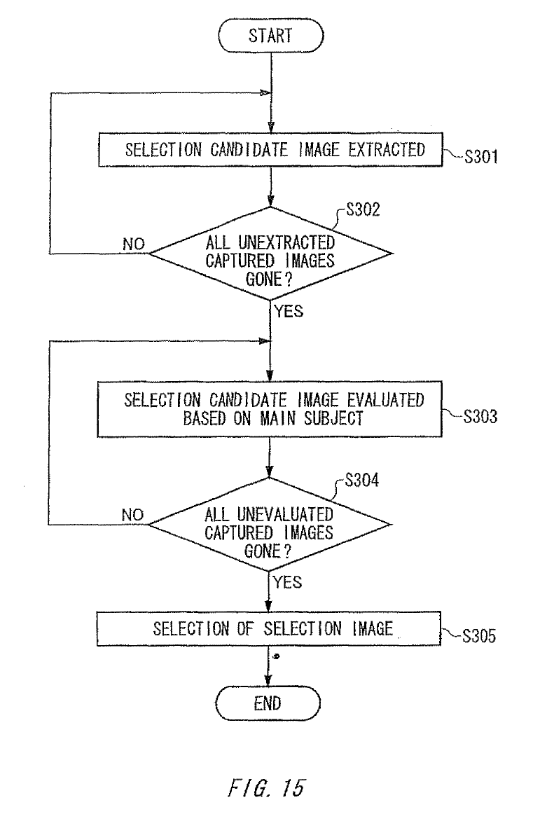

FIG. 15 is a flow chart showing the order of the operation performed by the image selecting section 280. First, the image selecting section 280 extracts a plurality of selection candidate images from the captured image group 410 (step S301). The selection candidate images are extracted from the captured images 414 to 41-n on a condition that the inferred main subject appears therein, for example, and the image selecting section 280 examines whether each of the captured images 41-1 to 41-n is a selection candidate image.

The image selecting section 280 repeats step S301 until there are no more captured images that could be selection candidate images (the NO of step S302). In a case where there are no more captured images that could be selection candidate images (the YES of step S302), the image selecting section 280 evaluates the picture quality of the main subject 27 for each of the selection candidate images (step S303).

While there are captured images remaining that could be selected (the NO of step S304), the image selecting section 280 repeats the evaluation of the picture quality of the main subject in each of the captured images (step S303). In a case where evaluation of all of the candidate images has been performed (the YES of step S304), at step S305, the image selecting section 280 selects an image in which the picture quality of the main subject is optimal based on the evaluation results, and ends the process. In this way, the image selection process of the captured image processing section 203 ends.

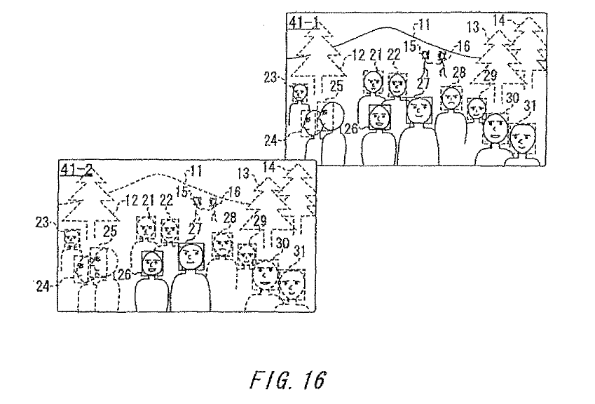

The following describes the processes of steps S303 and S305. FIG. 16 schematically shows a method performed by the image selecting section 280 for evaluating the selection candidate images based on the picture quality of the main subject 27. The subjects 11 to 16 and 21 to 31 appearing in the captured image 41-2 also appear in the initial captured image 41-1 of the captured image group 410. However, in the captured image 41-2, the depth of field changes for some reason, and the contrast of the subjects 11 to 16, 21 to 25, and 28 to 31 is lower than the contrast of the main subject 27.

In a case where the contrast of the main subject 27 is higher than that of the other subjects 11 to 16, 21 to 25, and 28 to 31 in the captured image 41-2 in this way, the image selecting section 280 determines that the main subject 27 is relatively emphasized in this image, and selects the captured image 41-2.

One subject 26 in the captured image 41-2 is positioned near the main subject 27, and is therefore captured with the same high contrast as the main subject 27. However, when all of the other subjects 11 to 16, 21 to 25, and 28 to 31 are considered and evaluated collectively, the contrast of the subjects 11 to 16, 21 to 25, and 28 to 31 can be evaluated as being lower than the contrast of the main subject 27.

The image selecting section 280 may calculate a high frequency component for the image data in the region of the main subject 27 in each selection candidate image, and set the image in which the cumulative value of the high frequency component within this region is at a maximum as the selection image. The calculation of the high frequency component can be achieved by extraction with a widely known high-pass filter or ACT calculation. In this way, an image in which the main subject 27 is well-focused can be selected from among the candidate images.

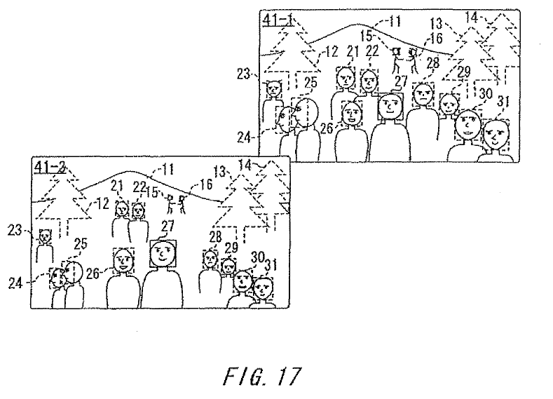

FIG. 17 schematically shows another method performed by the image selecting section 280 for evaluating the captured images based on the picture quality of the main subject 27. The subjects 11 to 14 and 21 to 31 appearing in the captured image 41-3 also appear in the initial captured image 41-1 of the captured image group 410. However, the position of the main subject 27 relative to the other subjects 11 to 14, 21 to 26, and 28 to 31 is different in the captured image 41-3.

As a result, the area in the captured image 41-3 occupied by the other subjects 11 to 16, 21 to 26, and 28 to 31 is smaller than in the captured image 41-1. In a case where the area occupied by the subjects 11 to 16, 21 to 26, and 28 to 31 is smaller in the captured image 41-3 in this way, the image selecting section 280 determines that the main subject 27 is relatively emphasized in the captured image 41-3 and selects the captured image 41-3.

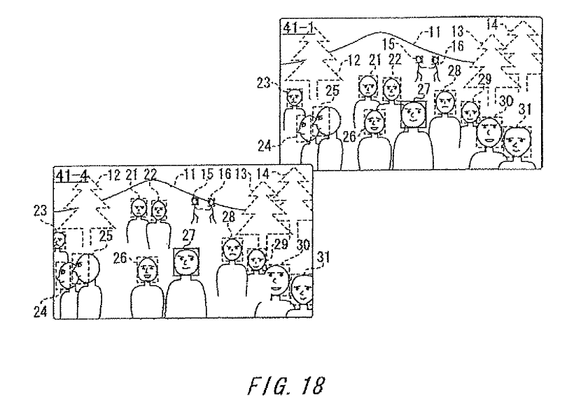

FIG. 18 schematically shows another method performed by the image selecting section 280 for evaluating selection candidate images based on the image capturing state of the unnecessary subjects 15, 16, 21 to 26, and 28 to 31. The subjects 15, 16, and 21 to 31 appearing in the captured image 41-4 also appear in the initial captured image 41-1 of the captured image group 410. However, the positions of the unnecessary subjects 15, 16, 21 to 26, and 28 to 31 are scattered in the captured image 41-4.

As a result, the positions of the unnecessary subjects 15, 16, 21 to 26, and 28 to 31 in the captured image 41-4 are closer to the periphery of the captured image 41-4 than in the captured image 41-1. In a case where the unnecessary subjects 15, 16, 21 to 26, and 28 to 31 are positioned closer to the edges in the captured image 41-4 in this way, the image selecting section 280 determines that the main subject 27 is relatively emphasized in the captured image 41-4 and selects the captured image 41-4.

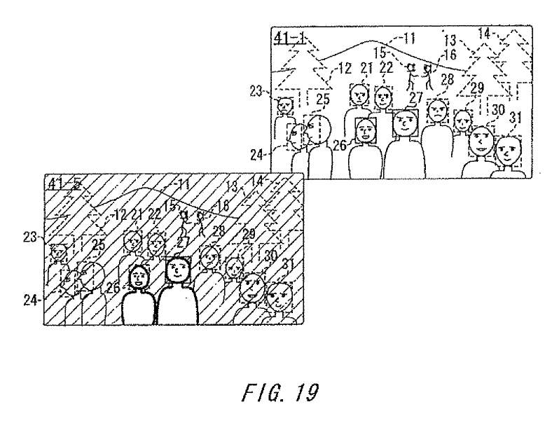

FIG. 19 schematically shows another method performed by the image selecting section 280 for evaluating selection candidate images based on the picture quality of the main subject 27. The subjects 11 to 16 and 21 to 31 appearing in the captured image 41-5 also appear in the initial captured image 41-1 of the captured image group 410. However, in the captured image 41-5, the main subject 27 is strongly illuminated and the other subjects 11 to 16, 21 to 25, and 28 to 31 appear relatively darker.

In a case where the main subject 27 appears brighter than the other subjects 11 to 16, 21 to 25, and 28 to 31 in the captured image 41-5 in this way, the image selecting section 280 determines that the main subject 27 is captured relatively brightly in this image and selects the captured image 41-5.

One subject 26 in the captured image 41-5 is captured with the same brightness as the main subject 27. However, when evaluated together with all of the other subjects 11 to 16, 21 to 25, and 28 to 31, the contrast of the main subject 27 is collectively higher than the contrast of the other subjects 11 to 14, 21 to 25, and 28 to 31.

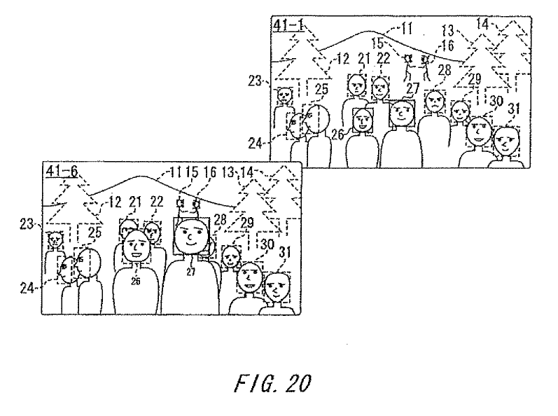

FIG. 20 schematically shows another method performed by the image selecting section 280 for evaluating selection candidate images based on the picture quality of the main subject 27. The subjects 11 to 14 and 21 to 31 appearing in the captured image 41-6 also appear in the initial captured image 41-1 of the captured image group 410. However, in the captured image 41-6, the size of the main subject 27 itself is changed significantly and the size relationship between the main subject 27 and the unnecessary subjects 11 to 14, 21 to 26, and 28 to 31 is different.

Therefore, the area occupied by the main subject 27 in the captured image 41-6 is greater than in the captured image 41-1. In a case where the area occupied by the main subject 27 in the captured image 41-6 is greater in this way, the image selecting section 280 determines that the main subject 27 is relatively emphasized in the captured image 41-6 and selects the captured image 41-6 as a selection image.

Instead of determining the main subject 27 to be emphasized based on selection images in which the size of the subject 27 is greater than the size of the other subjects 15, 16, 21 to 26, and 28 to 31, the image selecting section 280 may determine the selection candidate image in which the main subject 27 is largest to be the image in which the main subject 27 is emphasized.

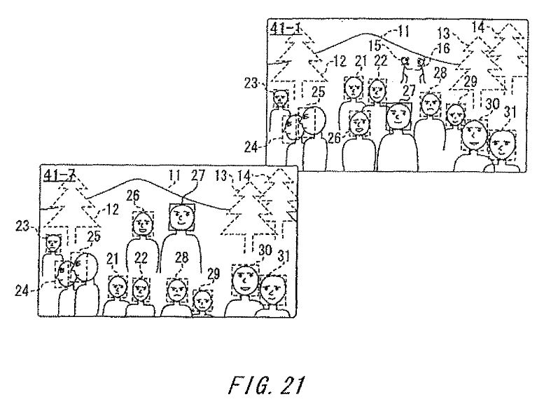

FIG. 21 schematically shows another method performed by the image selecting section 280 for evaluating selection candidate images based on the picture quality of the main subject 27. The subjects 11 to 14 and 21 to 31 appearing in the captured image 41-7 also substantially appear in the in the initial captured image 41-1 of the captured image group 410. However, in the captured image 41-7, the position of the main subject 27 is in the center of the capture field. In a case where the main subject 27 in the captured image 41-7 is near the predetermined position in this way, e.g. near the center of the captured image 41-7, the image selecting section 280 determines that the main subject 27 is relatively emphasized in the captured image 41-7 and selects the captured image 41-7.

In the above example, the closer the main subject 27 is to the center the more emphasized the main subject is determined to be, but the evaluation method is not limited to this. For example, the main subject 27 may be determined as being more emphasized the closer the main subject 27 is to each of three vertical lines and three horizontal lines uniformly dividing the screen, in order to avoid images in which the main subject 27 is positioned in the center of the screen.

In this way, the image selecting section 280 evaluates the picture quality of the main subject 27 in each of the captured images 414 to 41-n, and selects an image in which the main subject 27 is emphasized to be an image in which the image capturing state of the main subject 27 that is more important to the user is more favorable than the image capturing states of the other subjects 11 to 16, 21 to 26, and 28 to 31.

The order in which selection is performed based on the evaluation of the main subject is not limited to the order describer above. Furthermore, it is not necessary to perform all the steps of the above evaluation method for selection. The above evaluation method is merely one example, and may be used together with other evaluation methods or other evaluation criteria. An evaluation value for each evaluation criterion is calculated in the manner described above, and the captured images are ranked based on the evaluation values.

The captured images 41-2 to 41-7 selected by the image selecting section 280 in the manner described above may be provided to the user with priority in a case where the digital camera 100 is set in the play mode. As a result, the time necessary for the user to select captured images from among a large number of captured images is decreased. Furthermore, the digital camera 100 may delete captured images evaluated to be especially poor, or may prevent these images from being displayed until instructions are received from the user to display these images.

In this way, the image selecting section 280 determines how emphasized the main subject is in each of the captured images, and selects images in which the subject is in an optimal state. Accordingly, the effort involved in the user extracting selected images from among the captured images is decreased. In particular, the effort involved in extracting selected images can be greatly decreased by automatically identifying, as a selected image, one captured image having the main subject with the best picture quality. Furthermore, the selection processes by the user is not entirely removed, and the selection range of the image selecting section 280 may be increased to decrease the effort involved in the selection by the user. Instead of selecting images using the above process, the image selecting section 280 may identify an image and leave the selection up to the user. In this case, the image selecting section 280 may display the identified images in the rear display section 150 or the like in a manner to be distinguishable from the other images.

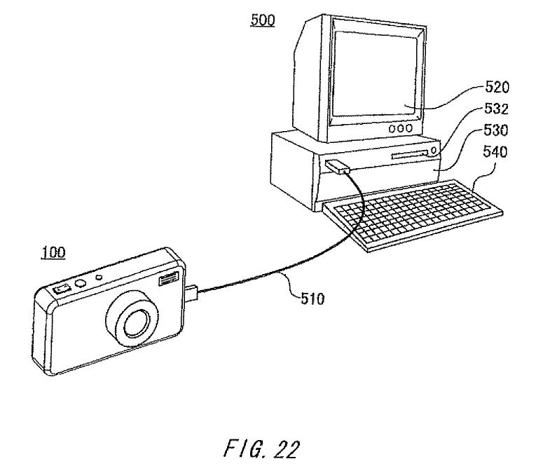

FIG. 22 schematically shows a personal computer 500 that executes an image capturing condition setting program. The personal computer 500 includes a display 520, a body portion 530, and a keyboard 540.

The body portion 530 can acquire image data of captured images from the digital camera 100, by communicating with the digital camera 100. The acquired image data can be stored in a storage medium of the personal computer 500. The personal computer 500 includes an optical drive 532 that is used in a case of loading a program to be executed.

The personal computer 500 described above operates as a captured image processing apparatus that executes the processes shown in FIGS. 4, 10, and 15 by reading a captured image processing program. The personal computer 500 can acquire the captured image data from the digital camera 100 via a cable 510 and set this data as a processing target.

Specifically, the captured image processing program includes a captured image acquiring process for acquiring a plurality of captured images in time sequence, a subject extraction process for extracting a plurality of different subjects contained in the images, and a main subject inferring process for determining the position of each subject in each of the images and inferring which of the subjects is the main subject in the images based on position information of each subject in the images. The captured image processing program causes the personal computer 500 to execute this series of processes.

As a result, the user can perform operation with a larger display 520 and a keyboard 540. By using the personal computer 500, a larger number of images can be processed more quickly. Furthermore, the number of evaluation criteria and may be increased and the evaluation units may be refined in each of the subject extracting process, the main subject inferring process, and the image selecting process. As a result, the intent of the user can be more accurately reflected when assisting with the image selection.

The transfer of the captured image data between the digital camera 100 and the personal computer 500 may be achieved through the cable 510, as shown in FIG. 22, or through wireless communication. As another example, the captured image data may be acquired from a secondary storage medium in which the captured image data is stored. The captured image processing program is not limited to being executed by the personal computer 500, and may instead be executed by print service equipment online or at a head office.

In the above embodiments, the candidate subjects for the main subject are extracted based on an evaluation that includes detecting the lines of sight of the subjects, an evaluation of how big the smiles of the subjects are, and an evaluation of appearance frequency, i.e. the number of frames in which each subject appears in the captured image frames, performed at steps S105 and S106. The main subject is then inferred based on a value corresponding to the distance from the center of the image to each candidate subject or on the number of frames in which each candidate subject appears in a predetermined region in the screen. But instead, the modification described below may be used.

First, the CPU 210 performs face recognition on a plurality of frame images acquired in time sequence, and then performs a tracking operation for each of the recognized faces. As a result, associations are made among the recognized faces between each of the captured image frames acquired in time sequence. The initial frame used in this tracking operation may be the image acquired immediately after the release button 144 is fully pressed, for example, the coordinates of each face in this initial frame may be set as the origin for the face, and each face is tracked among frames that were captured earlier and frames that were captured later. This tracking operation can be performed by using template matching with the face regions extracted during the face recognition as the templates.

In this way, for each face, an average value or integrated value of values corresponding to the distance from the center C of the image to the candidate subject in each frame and the number of frames in which the candidate subject appears in a predetermined region of the screen are calculated, and the main subject can be inferred based on this information using the same process as described above.

In this case, as described in the above embodiments, the evaluation may be performed while giving more weight to the image captured at the timing when the release button 144 was operated. In this way, the main subject that the photographer intends to capture is inferred in the series of captured images, and the position of the main subject in each image frame is identified.

Next, the picture quality of the inferred main subject is evaluated in each captured image frame based on the image characteristics of the captured image. The evaluation of the picture quality of the main subject based on the image characteristics may include the evaluation based on the lines of sight of the subjects or the evaluation based on how much the subjects are smiling, as described in steps S105 and S106, the contrast evaluation of the main subject described in relation to FIG. 16, the evaluation using the high frequency component of the image data of the main subject region, the evaluation based on the size of the main subject described in relation to FIGS. 17 and 20, the evaluation based on the position of the main subject and the other subjects described in relation to FIGS. 18 and 21, or the evaluation based on the brightness of the main subject described in relation to FIG. 19, for example.

As further examples, the picture quality of the main subject can be evaluated based on whether some or all of the main subject is outside of the captured image frames, whether the eyes of the main subject are closed, occlusion of the main subject, orientation of the main subject, or the amount of blur of the main subject as calculated from the high frequency component of the image data. Furthermore, the picture quality of the main subject can be evaluated using a combination of some or all of the above methods.

The judgment that a portion of the main subject is outside of the frame can be made by sequentially comparing the size and position of the main subject region between captured images in time sequence and detecting that the main subject region is positioned in contact with the edge of the captured image frame and is relatively smaller than the main subject in a temporally adjacent frame among the images in time sequence.

The judgment that all of the main subject is outside of the frame can be made by detecting that the main subject cannot be inferred, i.e. that there is a captured image frame in which the main subject is not present and therefore the tracking operation described above for associating the subjects with each other among the captured image frames could not be performed for this captured image frame.

This evaluation may be performed automatically, and images in which the main subject has high picture quality may be given priority when displayed to the photographer. Furthermore, frame images in which the main subject does not have good picture quality may be displayed to the user as deletion candidate images. The main subject inferring process described above may be performed by the main subject inferring section 270 based on the captured image data acquired through-image capturing (during preliminary image capturing), and the position and size information of the main subject in the through-image acquired immediately before the actual still image capturing performed later may be recorded in the secondary storage medium 322 by the image processing section 330 in association with the still image data from the actual image capturing. Based on the position and size information of the main subject in the through-image acquired immediately before the actual still image capturing, the position and size of the main subject may be inferred by the main subject inferring section 270 from the captured still image using template matching, for example, and this position and size information may be recorded in association with the still image data captured during the actual still image capturing. With this configuration, the effort exerted by the user to set the main subject region when editing the main subject region in the captured still image is eliminated. As another example, the main subject may be inferred by the main subject inferring section 270 performing the above method using through-image (or moving image) data captured during through-image (or moving image) capturing, and a region in the screen for acquiring evaluation values to be used in an autofocus operation by the automatic focusing section 340 may be set automatically for future through-image capturing (or moving image capturing or the actual still image capturing). For example, the main subject region may be inferred using the above method based on ten frames acquired after through-image capturing is begun, and the area from which the evaluation values are to be acquired may be set. Then, based on the image data in this region, the tracking operation of the main subject may be performed using template matching, for example, and the autofocus operation can be performed while updating the position of this region when desired. With this configuration, the autofocus operation can be performed without the user setting the region. Furthermore, images with special visual effects can be easily obtained by setting the region of the inferred main subject as a color image and setting the image data in all other regions to be monochromatic by setting the color difference image data to be 0 to create a black and white image, for example. When capturing a through-image (or a moving image), if the image is displayed in the rear display section 150, the user can easily understand the position of the main subject within the screen even in a case where the area of the display screen of the rear display section 150 is small or in a case where the main subject is small, and an image with suitable composition can be easily obtained by moving the image capturing apparatus to optimize the position of the main subject.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An image processing apparatus comprising:
an image acquiring section that acquires a plurality of images captured in time sequence;
a subject extracting section that extracts a plurality of different subjects contained in the plurality of images; and
a main subject inferring section that determines the position of each subject in each of the images, and infers which of the subjects is a main subject in the images based on position information for each of the subjects in the images.

2. The image processing apparatus according to claim 1, wherein the main subject inferring section infers which of the subjects is the main subject based on information concerning the history of the position of each subject in the images.

3. The image processing apparatus according to claim 1, wherein the subject extracting section detects a plurality of faces as the subjects, and the main subject inferring section determines the position of each subject in the images by individually tracking each of the faces across the images.

4. The image processing apparatus according to claim 1, wherein the main subject inferring section infers the main subject based on a value, calculated for each subject, corresponding to distance of the subject from a reference position in the images that is common among the images.

5. The image processing apparatus according to claim 1, wherein the main subject inferring section infers the main subject based on the number of frames, calculated for each subject, in which the subject appears in a reference region in the images that is common among the images.

6. The image processing apparatus according to claim 1, wherein the main subject inferring section performs an evaluation in which subjects appearing in images from among the plurality of images captured in time sequence that are captured at timings closer to a timing at which image capturing instructions are issued are given more weight.

7. The image processing apparatus according to claim 1, further comprising an image specifying section that, according to results of an evaluation of image characteristics of a region of the main subject inferred by the main subject inferring section in the plurality of images, specifies an image from among the plurality of images in which the main subject is best captured.

8. The image processing apparatus according to claim 7, wherein from among the plurality of images, the image specifying section identifies at least one of an image in which contrast or a high frequency component of the region of the main subject inferred by the main subject inferring section is greater than in the other images, an image in which area occupied by the region of the main subject is greater than in the other images, an image in which the position of the region of the main subject is closer to a predetermined position within the image than in the other images, and an image that does not include an image in which at least a portion of the main subject is out of frame.

9. The image processing apparatus according to claim 7, wherein
the main subject is a person, and
the image specifying section identifies an image in which the main subject is best captured, from among the plurality of images, based on at least one of a degree of blurring of the main subject inferred by the main subject inferring section, a degree of defocusing of the main subject, line of sight orientation of the main subject, whether the eyes of the main subject are open or closed, and how much of a smile the main subject has.

10. An image capturing apparatus comprising:
the image processing apparatus according to claim 1;
a release button that is operated by a user, and
an image capturing section that captures the plurality of images in response to a single operation of the release button.

11. The image capturing apparatus according to claim 10, wherein
the subject extracting section extracts the plurality of subjects from one image among the plurality of images that is determined according to a timing at which the release button is operated, and
with the one image set as an initial frame, the main subject inferring section determines positions of each of the subjects in the plurality of images by individually tracking each subject across images captured earlier than the initial frame and images captured later than the initial frame.

12. An image capturing apparatus comprising:
the image processing apparatus according to claim 1;
an image capturing section that captures a plurality of images as preliminary images, and captures a main image after capturing the preliminary images; and
an automatic focusing section that performs focusing for the image capturing section, wherein
the main subject inferring section infers the main subject and infers a position of the main subject within a screen using the preliminary images, and
for following preliminary image capturing, the automatic focusing section sets a region to be focused based on the position of the main subject in the screen inferred by the main subject inferring section.

13. The image capturing apparatus according to claim 12, further comprising a recording section that records the position of the main subject in the screen inferred by the main subject inferring section using the preliminary images captured before the main image, in association with the main image.

14. The image capturing apparatus according to claim 12, further comprising a display section that displays images, wherein
the display section displays a region containing the main subject inferred by the main subject inferring section in color, and displays other regions in monochrome.

15. A recording medium storing thereon a program that causes a computing device to:
capture a plurality of images in time sequence;
extract a plurality of different subjects contained in the plurality of images; and
determine a position of each subject in each of the images, and infer which of the subjects is a main subject in the images based on position information for each of the subjects in the images.
